(19) United States
(12) Patent Application Publication
(10) Pub. No.: US 2025/0310845 A1
(43) Pub. Date: Oct. 2, 2025

(54) ON-DEMAND SYNCHRONIZATION SIGNAL BLOCK CONFIGURATION FOR CONNECTED STATE MOBILITY

(71) Applicant: QUALCOMM Incorporated, San Diego, CA (US)

(72) Inventors: Hyunwoo CHO, San Diego, CA (US); Prashant SHARMA, San Marcos, CA (US); Changhwan PARK, San Diego, CA (US)

(21) Appl. No.: 19/062,799

(22) Filed: Feb. 25, 2025

Related U.S. Application Data
(60) Provisional application No. 63/573,206, filed on Apr. 2, 2024.

(51) Int. Cl. H04W 36/08; H04W 36/00; H04W 56/00

(52) U.S. Cl. CPC H04W 36/08; H04W 36/008355; H04W 56/0015

(57) ABSTRACT

Various aspects of the present disclosure generally relate to wireless communication. In some aspects, a user equipment (UE) may receive, via a first cell, a first communication that is associated with a connected state mobility operation, the first communication indicating on-demand synchronization signal block (SSB) configuration information for a second cell. The UE may receive, via the second cell, one or more on-demand SSBs in accordance with the on-demand SSB configuration information. The UE may transmit, to the second cell, a second communication associated with the connected state mobility operation, the second communication using information indicated by the one or more on-demand SSBs. Numerous other aspects are described.

### CROSS-REFERENCE TO RELATED APPLICATION

The present application for patent claims priority under 35 U.S.C. § 119 to U.S. Provisional Patent Application No. 63/573,206, filed on Apr. 2, 2024, entitled “ON-DEMAND SYNCHRONIZATION SIGNAL BLOCK CONFIGURATION FOR CONNECTED STATE MOBILITY,” which is assigned to the assignee hereof and hereby expressly incorporated by reference herein.

### FIELD OF THE DISCLOSURE

Aspects of the present disclosure generally relate to wireless communication and specifically relate to techniques, apparatuses, and methods for an on-demand synchronization signal block configuration for connected state mobility.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a synchronization signal (SS) hierarchy, in accordance with the present disclosure.

FIG. 5 is a diagram illustrating an example of a network energy saving (NES) operation, in accordance with the present disclosure.

FIG. 6 is a diagram illustrating examples of handover interruption, in accordance with the present disclosure.

FIG. 7 is a diagram of an example associated with an on-demand SS block (SSB) configuration for connected state mobility, in accordance with the present disclosure.

FIG. 8 is a diagram of an example associated with an on-demand SSB configuration for connected state mobility, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### SUMMARY

Some aspects described herein relate to a user equipment (UE) for wireless communication. The UE may include one or more memories and one or more processors coupled to the one or more memories. The one or more processors may be configured to receive, via a first cell, a first communication that is associated with a connected state mobility operation, the first communication indicating on-demand synchronization signal block (SSB) configuration information for a second cell. The one or more processors may be configured to receive, via the second cell, one or more on-demand SSBs in accordance with the on-demand SSB configuration information. The one or more processors may be configured to transmit, to the second cell, a second communication associated with the connected state mobility operation, the second communication using information indicated by the one or more on-demand SSBs.

Some aspects described herein relate to a method of wireless communication performed by a UE. The method may include receiving, via a first cell, a first communication that is associated with a connected state mobility operation, the first communication indicating on-demand SSB configuration information for a second cell. The method may include receiving, via the second cell, one or more on-demand SSBs in accordance with the on-demand SSB configuration information. The method may include transmitting, to the second cell, a second communication associated with the connected state mobility operation, the second communication using information indicated by the one or more on-demand SSBs.

Some aspects described herein relate to a non-transitory computer-readable medium that stores a set of instructions for wireless communication by a UE. The set of instructions, when executed by one or more processors of the UE, may cause the UE to receive, via a first cell, a first communication that is associated with a connected state mobility operation, the first communication indicating on-demand SSB configuration information for a second cell. The set of instructions, when executed by one or more processors of the UE, may cause the UE to receive, via the second cell, one or more on-demand SSBs in accordance with the on-demand SSB configuration information. The set of instructions, when executed by one or more processors of the UE, may cause the UE to transmit, to the second cell, a second communication associated with the connected state mobility operation, the second communication using information indicated by the one or more on-demand SSBs.

Some aspects described herein relate to an apparatus for wireless communication. The apparatus may include means for receiving, via a first cell, a first communication that is associated with a connected state mobility operation, the first communication indicating on-demand SSB configuration information for a second cell. The apparatus may include means for receiving, via the second cell, one or more on-demand SSBs in accordance with the on-demand SSB configuration information. The apparatus may include means for transmitting, to the second cell, a second communication associated with the connected state mobility operation, the second communication using information indicated by the one or more on-demand SSBs.

Some aspects described herein relate to a network node for wireless communication. The network node may include one or more memories and one or more processors coupled to the one or more memories. The one or more processors may be configured to receive on-demand SSB configuration information for a first cell. The one or more processors may be configured to transmit, via a second cell and for a UE, a communication that is associated with a connected state mobility operation, the communication indicating the on-demand SSB configuration information.

Some aspects described herein relate to a method of wireless communication performed by a network node. The method may include receiving on-demand SSB configuration information for a first cell. The method may include transmitting, via a second cell and for a UE, a communication that is associated with a connected state mobility operation, the communication indicating the on-demand SSB configuration information.

Some aspects described herein relate to a non-transitory computer-readable medium that stores a set of instructions for wireless communication by a network node. The set of instructions, when executed by one or more processors of the network node, may cause the network node to receive on-demand SSB configuration information for a first cell. The set of instructions, when executed by one or more processors of the network node, may cause the network node to transmit, via a second cell and for a UE, a communication that is associated with a connected state mobility operation, the communication indicating the on-demand SSB configuration information.

Some aspects described herein relate to an apparatus for wireless communication. The apparatus may include means for receiving on-demand SSB configuration information for a first cell. The apparatus may include means for transmitting, via a second cell and for a UE, a communication that is associated with a connected state mobility operation, the communication indicating the on-demand SSB configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy saving (NES) and/or network energy efficiency measures are expected to have increased importance in wireless network operations for various reasons, such as climate change mitigation, environmental sustainability, and/or network cost reduction, among other examples. For example, although New Radio (NR) generally offers a significant energy efficiency improvement per gigabyte over previous generations (for example, Long Term Evolution (LTE)), new NR use cases and/or the adoption of millimeter wave frequencies may use more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN may be to enable “on-demand” broadcast transmissions by a network node and/or a cell. For example, to reduce power consumption at a network node, the network node may transmit certain broadcast communications (e.g., system information communications, synchronization signal blocks (SSBs), and/or system information blocks (SIBs)) in an on-demand manner (e.g., rather than on a periodic basis or following a periodic schedule). In some examples, one or more SSBs and/or SIBs may be transmitted via a cell to support initial access by UEs and measurement by UEs, among other examples. Typically, such communications are periodically transmitted via the cell (e.g., following some periodic schedule where the communications are transmitted one or more times each period). Therefore, one way to reduce network power consumption is to reduce a quantity of transmissions of such communications so that, for example, SSBs and SIBs are transmitted less frequently by a cell operating in an NES mode (or NES state). As an example, SSBs and/or SIBs may be transmitted in an on-demand manner by a cell to conserve network power by the cell.

To support initial access and/or measurements of the cell, a user equipment (UE) may receive one or more types of broadcast communications from the cell (e.g., SSBs and/or SIBs). However, the cell (e.g., operating in an NES mode) may not periodically transmit the one or more types of broadcast communications, or may transmit the one or more types of broadcast communications infrequently (e.g., with large SSB measurement time configuration (SMTC) windows, such as 160 milliseconds or larger), thereby reducing opportunities for the UE to access the cell and/or to perform measurements of the cell.

In some examples, there may be a handover delay in handover scenarios where radio resource control (RRC) signaling is used to trigger a handover from a source cell to a target cell. For example, an interruption time (e.g., a time during which data is not transmitted to or from the UE) during the handover delay may be defined by one or more factors, such as a search time. The search time may be a period of time during which the UE searches for a target cell. The search time may be 0 milliseconds when the target cell is known to the UE when the handover command is received by the UE. As used herein, a “known” cell may refer to a cell that the UE has previously measured, evaluated, and/or obtained information about. An “unknown” cell may refer to a cell that the UE has not previously (or has not recently) measured and/or for which the UE has no (or limited) information. In some examples, when the target cell is an unknown intra-frequency target cell, the search time may be a reference signal time (T_rs) in FR1, or N×T_rs in FR2 (e.g., where N is 8 for FR2-1 and where N is 12 for FR2-2). When the target cell is an unknown inter-frequency target cell, the search time may be 3×T_rs in FR1, or N×3×T_rs in FR2. T_rs may be an SMTC periodicity of the target cell if the UE has been provided with an SMTC configuration for the target cell in the handover command. Otherwise, T_rs may be an SMTC configured in a measurement object (e.g., an measObjectNR) having the same SSB frequency and subcarrier spacing as the target cell.

As described above, for unknown target cells, a dominant factor for the interruption time may be the search time. For example, for unknown target cells, the search time may make up a largest portion of the interruption time. In some examples, the target cell may be operating in an NES mode. In such examples, the target cell may be capable of transmitting and/or may be configured to transmit on-demand SSBs, as described in more detail elsewhere herein. In such examples, an SMTC periodicity (e.g., an amount of time between SMTC windows or between SSB burst sets) for the target cell may be large, such as 160 milliseconds or larger. For example, the target cell may transmit SSBs less frequently when operating in the NES mode. In such examples, the interruption time for handover to the target cell may significantly increase if the target cell is unknown by the UE. For example, assuming an SMTC period of 160 milliseconds, the search time may be 480 milliseconds for an unknown inter-frequency target cell in FR1. The increased interruption time for handover to the target cell may increase a delay for the UE to complete the handover procedure to the target cell. Similarly, for other connected state mobility operations, a dominant factor for the interruption time may be the SMTC periodicity for the target cell. For example, for RRC redirection operations, a time for the UE to identify a target cell may be a factor of T_rs (e.g., which may be the SMTC periodicity of the target cell). The increased interruption time may increase latency for data to be transmitted to the UE or transmitted by the UE, may reduce throughput for the UE, and/or may otherwise degrade performance of the UE. For example, during the interruption time, no data may be transmitted to the UE and/or no data may be transmitted by the UE. As a result, a mobility performance of the UE may be degraded because of the increased interruption time during handover to the target cell.

Various aspects relate generally to on-demand SSB configuration for connected state mobility. Some aspects more specifically relate to a source cell configuring an on-demand SSB configuration of a target cell for a UE in a communication that is associated with initiating a connected state mobility operation. The connected state mobility operation may be a mobility operation that is initiated while the UE is in a connected state (e.g., an RRC connected state). For example, a connected state mobility operation may be a handover operation, and/or an RRC redirection operation (e.g., an RRC release with redirection to a target cell associated with a different radio access technology (RAT) than the source cell, such as RRC release with redirection to NR), among other examples.

The source cell may (or another network node may) cause the target cell to transmit one or more on-demand SSBs as part of the connected state mobility operation (e.g., in accordance with the on-demand SSB configuration). For example, the source cell and the target cell may perform backhaul coordination to cause the target cell to transmit on-demand SSBs in accordance with the on-demand SSB configuration during the connected state mobility operation for the UE. The UE may receive and/or measure the one or more on-demand SSBs as part of the connected state mobility operation. The UE may transmit a communication (e.g., a random access channel (RACH) communication) to establish a connection with the target cell using information indicated by the one or more on-demand SSBs.

In some aspects, a reference signal time (T_rs) for the connected state mobility operation may be based on, or otherwise associated with, the on-demand SSB configuration. For example, the T_rs for the connected state mobility operation may be based on, or otherwise associated with, a time gap between burst sets indicated by the on-demand SSB configuration.

Particular aspects of the subject matter described in this disclosure can be implemented to realize one or more of the following potential advantages. In some examples, by indicating the on-demand SSB configuration in the communication that is associated with initiating a connected state mobility operation, the described techniques can be used to enable the UE to use information indicated by one or more on-demand SSBs to perform the connected state mobility operation. By using the one or more on-demand SSBs to perform the connected state mobility operation, the described techniques can be used to reduce a delay or interruption time associated with the connected state mobility operation. For example, the on-demand SSBs may be transmitted more frequently than other SSBs transmitted by the target cell. For example, by using the on-demand SSBs, the interruption time may be defined based on, using, or otherwise associated with the time gap between burst sets indicated by the on-demand SSB configuration (e.g., which may be less than the SMTC periodicity of an SSB configuration of the target cell). This may reduce the interruption time for the connected state mobility operation, thereby reducing latency or delay for data to be transmitted to and/or from the UE (e.g., because the UE may be enabled to establish a connection with the target cell with reduced delay by using the one or more on-demand SSBs to perform the connected state mobility operation). This may improve the mobility performance and/or increase throughput of the UE.

Additionally, by coordinating and/or causing the target cell to transmit the one or more on-demand SSBs during the connected state mobility operation, a resource utilization efficiency of the on-demand SSBs may be improved. For example, by enabling the target cell to transmit the one or more on-demand SSBs during the connected state mobility operation, the target cell may transmit the one or more on-demand SSBs in a more efficient manner (e.g., because the target cell is transmitting the on-demand SSBs at a time that is useful for the UE for the connected state mobility operation). This enables the target cell to improve power savings (e.g., by operating in an NES mode with on-demand SSBs enabled and with sparse periodic SSB transmissions) without degrading the performance of UEs attempting to establish connections with the target cell as part of a connected state mobility operation and/or without increasing the interruption time associated with the connected state mobility operation, among other examples.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

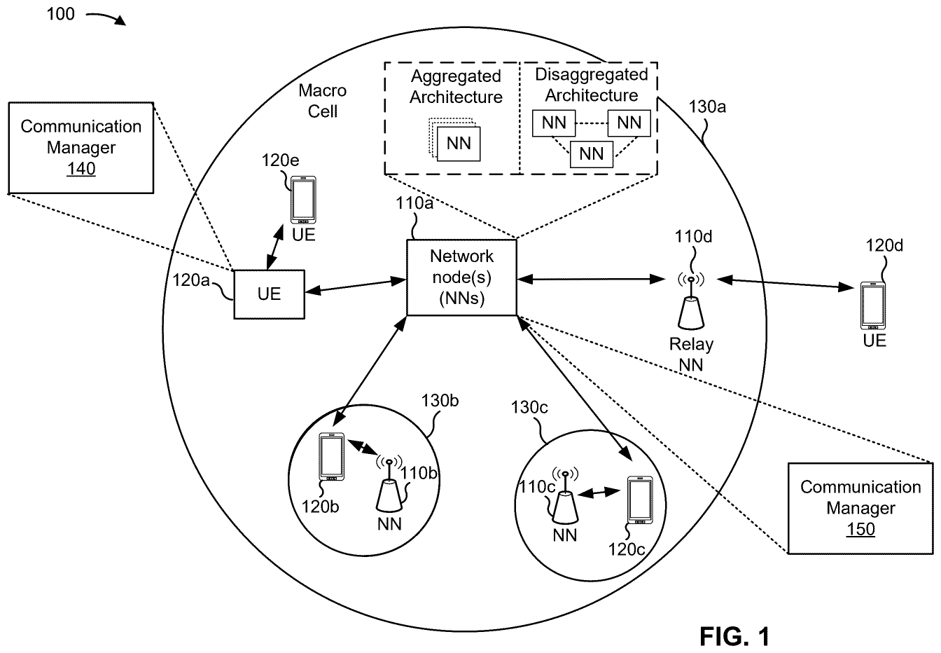

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, via a first cell, a first communication that is associated with a connected state mobility operation, the first communication indicating on-demand SSB configuration information for a second cell; receive, via the second cell, one or more on-demand SSBs in accordance with the on-demand SSB configuration information; and transmit, to the second cell, a second communication associated with the connected state mobility operation, the second communication using information indicated by the one or more on-demand SSBs. Additionally, or alternatively, the communication manager 140 may perform one or more other operations described herein.

In some aspects, the network node 110 may include a communication manager 150. As described in more detail elsewhere herein, the communication manager 150 may receive on-demand SSB configuration information for a first cell; and transmit, via a second cell and for a UE, a communication that is associated with a connected state mobility operation, the communication indicating the on-demand SSB configuration information. Additionally, or alternatively, the communication manager 150 may perform one or more other operations described herein.

As indicated above, FIG. 1 is provided as an example. Other examples may differ from what is described with regard to FIG. 1.

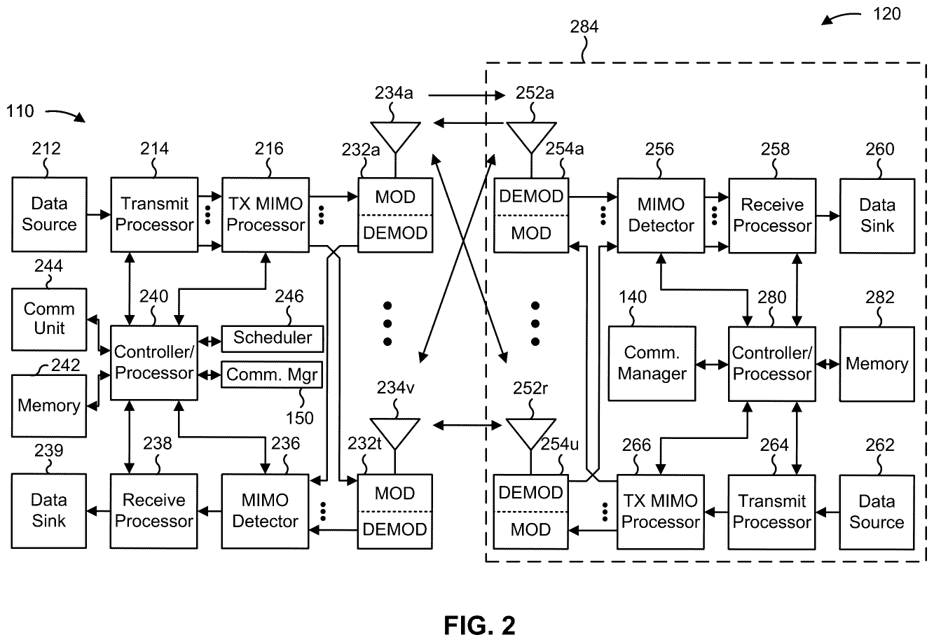

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

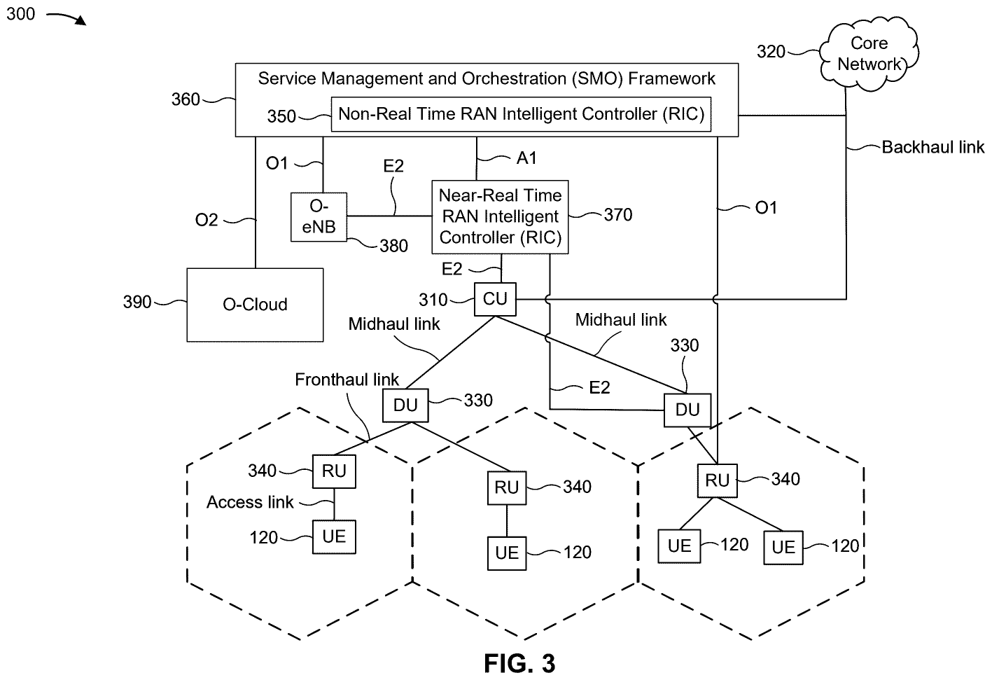

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

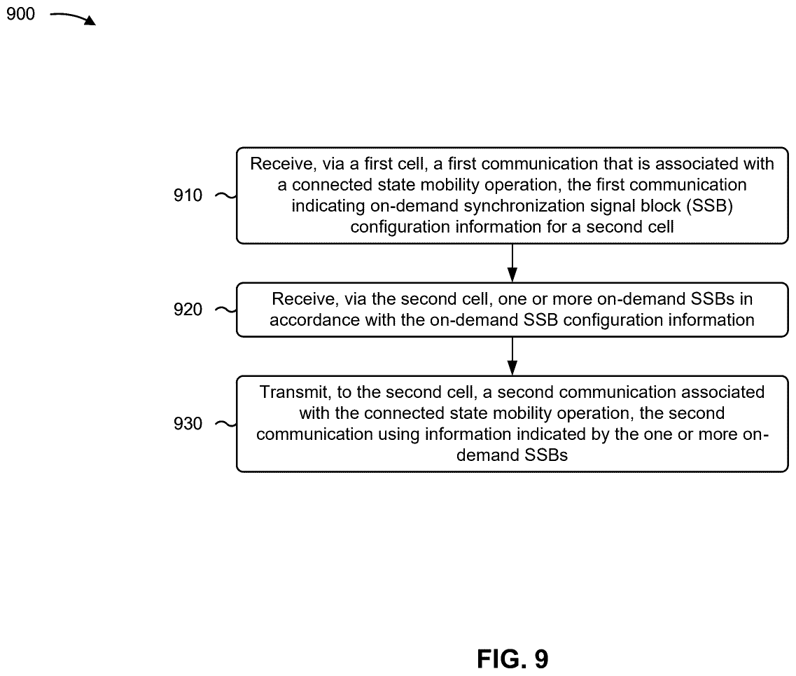

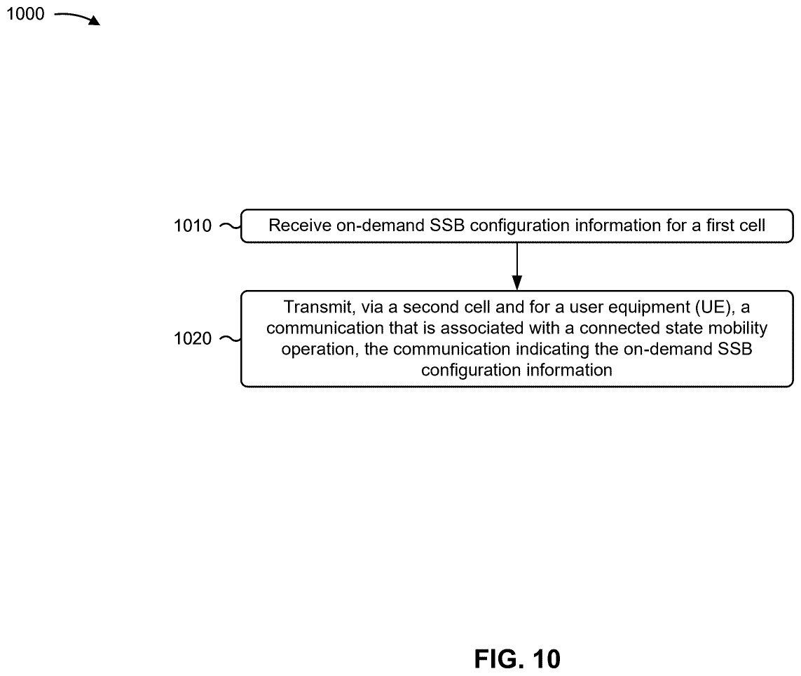

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with an on-demand SSB configuration for connected state mobility, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving, via a first cell, a first communication that is associated with a connected state mobility operation, the first communication indicating on-demand SSB configuration information for a second cell; means for receiving, via the second cell, one or more on-demand SSBs in accordance with the on-demand SSB configuration information; and/or means for transmitting, to the second cell, a second communication associated with the connected state mobility operation, the second communication using information indicated by the one or more on-demand SSBs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving on-demand SSB configuration information for a first cell; and/or means for transmitting, via a second cell and for a UE, a communication that is associated with a connected state mobility operation, the communication indicating the on-demand SSB configuration information. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

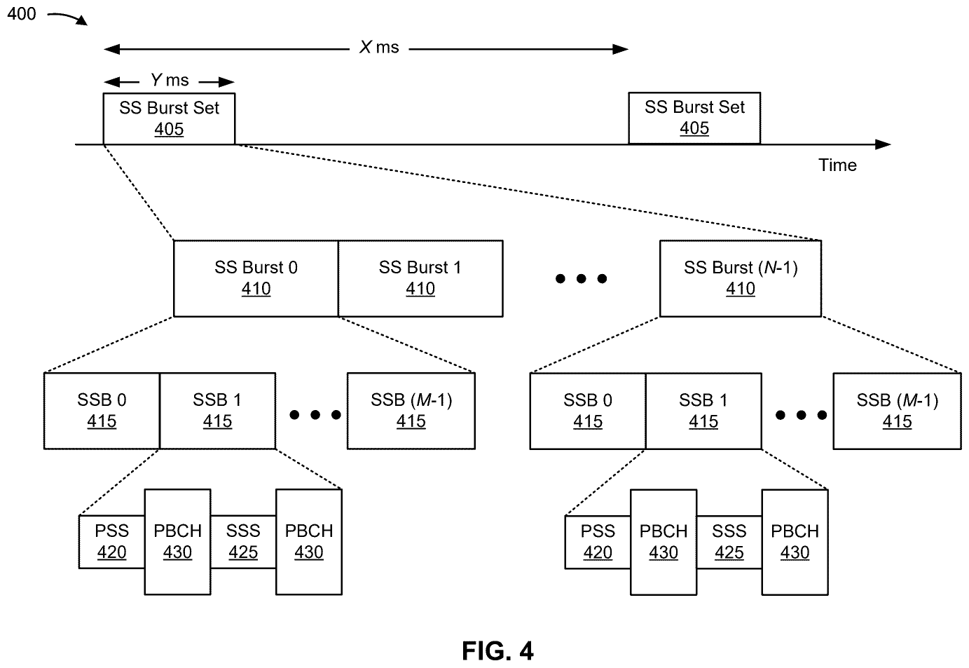

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SS blocks (SSBs) 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a primary synchronization signal (PSS) 420, a secondary synchronization signal (SSS) 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

In some examples, an SSB 415 may be a cell-defining SSB (CD-SSB) or a non-cell-defining SSB (NCD-SSB). As used herein, “CD-SSB” refers to an SSB that indicates a system information block (SIB) message including an identifier associated with the cell (e.g., an NR cell global identity (NCGI)). In some aspects, a CD-SSB may carry system information, such as remaining minimum system information (RMSI). For example, the SIB included in the CD-SSB may be a SIB1, as defined or otherwise fixed by a wireless communication standard, such as the 3GPP. In some aspects, the CD-SSB may enable RMSI acquisition. “NCD-SSB” refers to an SSB that does not indicate the SIB message and/or indicates a SIB message not including the identifier associated with the cell. For example, an NCD-SSB may not include SIB1 or RMSI.

In some examples, one or more SSBs 415 may be transmitted in an on-demand manner (e.g., in addition to, or rather than, periodically). For example, an on-demand SSB may be an SSB 415 that is transmitted based on, in response to, or otherwise associated with an event or trigger (e.g., rather than in accordance with a set periodic schedule). The event or trigger may be a network node 110 receiving a request (e.g., from a UE 120 or from another network node 110) to transmit the on-demand SSB(s). As another example, the event or trigger may be an activation of a cell, such as a secondary cell (SCell) activation. A trigger for a network node 110 to transmit on-demand SSBs may include receiving a signal from a UE 120 (e.g., a UE uplink wakeup signal or another signal) to the network node 110, a cell on/off indication via backhaul signaling, and/or an SCell activation and/or deactivation signaling, among other examples. Transmitting on-demand SSBs may improve network power savings because a network node 110 may reduce the quantity of SSB transmissions (e.g., by not transmitting the SSBs 415 periodically and/or by increasing the amount of time (e.g., X) between SS burst sets 405). In other words, a network node 110 may utilize on-demand SSBs to reduce power consumption by only transmitting SSBs 415 in an on-demand manner (e.g., rather than an “always on” manner) and/or by transmitting SSBs more infrequently or sporadically. In some examples, a network node 110 may periodically transmit one or more NCD-SSBs with a large time gap between SS burst sets 405 (such as 160 milliseconds or larger) to improve power savings (e.g., because the NCD-SSBs use less energy to transmit than CD-SSBs and/or SIB1). Additionally, or alternatively, the network node 110 may periodically transmit one or more CD-SSBs with a large time gap between SS burst sets 405 (such as 160 milliseconds or larger) to improve power savings.

On-demand SSBs may be used by a UE 120 for time synchronization and/or frequency synchronization (e.g., SCell time synchronization and/or SCell frequency synchronization), Layer 1 (L1) measurements, Layer 3 (L3) measurements, and/or SCell activation, among other examples. On-demand SSBs may be supported for one or more frequency ranges, such as FR1, FR2, and/or other frequency ranges (e.g., in a non-shared spectrum). In some examples, on-demand SSBs may be used to support SCell operations for UEs in a connected mode (e.g., an RRC connected mode) configured with carrier aggregation (e.g., for intra-band carrier aggregation and/or inter-band carrier aggregation). For example, an SCell may transmit on-demand SSBs to improve power savings for the SCell.

As indicated above, FIG. 4 is provided as an example. Other examples may differ from what is described with regard to FIG. 4.

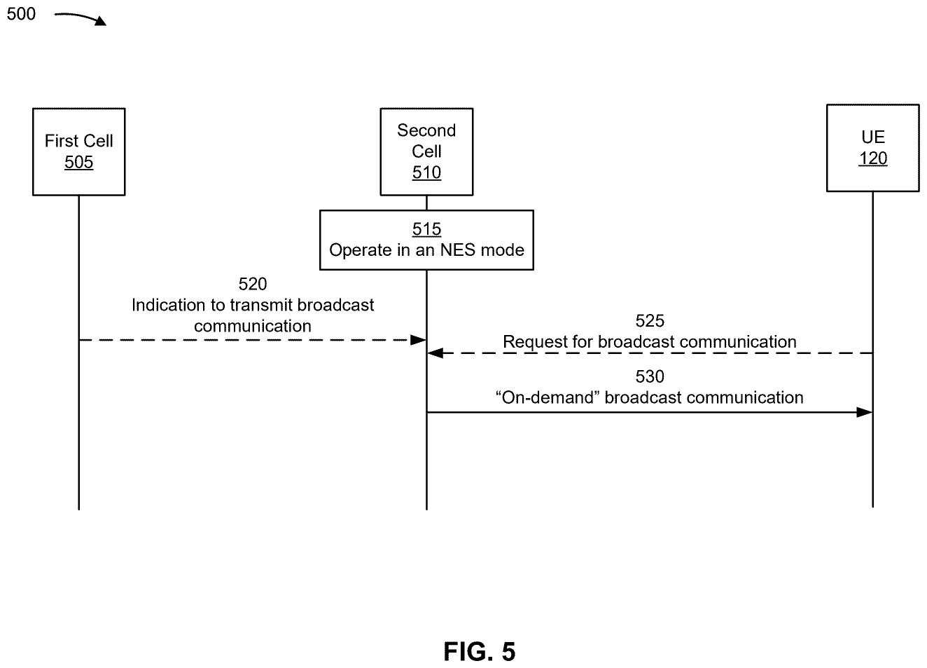

FIG. 5 is a diagram illustrating an example of a network energy saving (NES) operation 500, in accordance with the present disclosure.

NES and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (for example, LTE), new NR use cases and/or the adoption of millimeter wave frequencies may use more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN may be to enable “on-demand” broadcast transmissions by a network node 110 and/or a cell. For example, to reduce power consumption at a network node 110, the network node 110 may transmit certain broadcast communications (e.g., system information communications, SSBs, and/or system information blocks (SIBs)) in an on-demand manner (e.g., rather than on a periodic basis or following a periodic schedule). In some examples, one or more SSBs and/or SIB may be transmitted via a cell to support initial access by UEs and measurement by UEs, among other examples. Typically, such communications are periodically transmitted via the cell (e.g., following some periodic schedule where the communications are transmitted one or more times each period). Therefore, one way to reduce network power consumption is to reduce a quantity of transmissions of such communications so that, for example, SSBs and SIBs are transmitted less frequently by a cell operating in an NES mode (or NES state). As an example, SSBs and/or SIBs may be transmitted in an on-demand manner by a cell to conserve network power by the cell.

As shown in FIG. 5, an first cell 505, a second cell 510, and a UE 120 may communicate with each other. The second cell 510 may be an SCell and/or an NES cell. As used herein, “NES” cell refers to a cell (or a network node 110) that is operating in an NES mode (or NES state). The first cell 505 may be an anchor cell or a primary cell (PCell). As used herein, “anchor” cell refers to a cell (or network node 110) that is configured to assist and/or control operations of an NES cell. In some examples, the first cell 505 may be a PCell and the second cell 510 may be an SCell. For example, in carrier aggregation, the UE 120 may be configured with a primary carrier or PCell and one or more secondary carriers or SCells. In some aspects, the PCell may carry control information (e.g., downlink control information and/or scheduling information) for scheduling data communications on one or more SCells. In some examples, the first cell 505 and the second cell 510 may be associated with (e.g., controlled by or supported by) the same network node 110. In other examples, the first cell 505 and the second cell 510 may be associated with (e.g., controlled by or supported by) different network nodes 110.

As shown by reference number 515, the second cell 510 may operate in an NES mode. For example, the second cell 510 may transmit one or more types of broadcast communications (e.g., SSBs and/or SIB1) in an on-demand manner. For example, when the second cell 510 is not operating in the NES mode, the second cell 510 may transmit the one or more types of broadcast communications periodically. However, to conserve power or energy resources, the second cell 510 may transmit the one or more types of broadcast communications (e.g., SSBs and/or SIB1) in an on-demand manner when operating in the NES mode.

In some aspects, the UE 120 may be operating in an idle mode (e.g., an RRC idle mode) or an inactive mode (e.g., an RRC inactive mode). In other aspects, the UE 120 may be operating in a connected mode (e.g., an RRC connected mode). For example, the UE 120 may support a connected mode (e.g., an RRC connected mode), an idle mode (e.g., an RRC idle mode), and an inactive mode (e.g., an RRC inactive mode). The RRC connected mode may sometimes be referred to as an RRC active mode. The RRC inactive mode may functionally reside between the RRC connected mode and the RRC idle mode. The UE 120 may transition between different modes based at least in part on various commands and/or communications received from one or more network nodes 110. For example, the UE 120 may transition from RRC connected mode or RRC inactive mode to RRC idle mode based at least in part on receiving an RRCRelease communication. As another example, the UE may transition from RRC connected mode to RRC inactive mode based at least in part on receiving an RRCRelease with suspendConfig communication. As another example, the UE 120 may transition from RRC idle mode to RRC connected mode based at least in part on receiving an RRCSetupRequest communication. As another example, the UE 120 may transition from RRC inactive mode to RRC connected mode based at least in part on receiving an RRCResumeRequest communication. When transitioning to RRC inactive mode, the UE 120 and/or the one or more network nodes 110 may store a UE context (e.g., an access stratum (AS) context and/or higher-layer configurations). This enables the UE 120 and/or the one or more network nodes 110 to apply the stored UE context when the UE 120 transitions from RRC inactive mode to RRC connected mode in order to resume communications with the one or more network nodes 110, which reduces latency of transitioning to the RRC connected mode relative to transitioning to the RRC connected mode from RRC idle mode. When the UE 120 is operating in the RRC idle mode, the UE context may not be stored for the UE 120 (e.g., by a cell, such as the first cell 505 or the second cell 510).

To support mobility of the UE 120 may receive one or more types of broadcast communications from the second cell 510 (e.g., SSBs and/or SIB1). However, the second cell 510 (e.g., operating in the NES mode) may not periodically transmit the one or more types of broadcast communications, or may transmit the one or more types of broadcast communications infrequently (e.g., with large SMTC periodicities, such as 160 milliseconds or larger), thereby reducing opportunities for the UE 120 to access the second cell 510 and/or to perform measurements of the second cell 510.

In some examples, the second cell 510 may be triggered to transmit the one or more types of broadcast communications from the second cell 510 (e.g., SSBs and/or SIB1). For example, as shown by reference number 520, the first cell 505 may transmit, and the second cell 510 may receive, an indication to transmit one or more broadcast communications (e.g., SSBs and/or SIB1). For example, the first cell 505 may indicate to the second cell 510 to transmit the SSBs and/or SIB1 via backhaul coordination (e.g., via a cell on or off indication via a backhaul link or a midhaul link). As another example, the first cell 505 may indicate to the second cell 510 to transmit the SSBs and/or SIB1 via SCell activation or deactivation signaling.

Additionally, or alternatively, as shown by reference number 525, the UE 120 may transmit, and the second cell 510 may receive, a request for one or more broadcast communications (e.g., SSBs and/or SIB1). In some examples, the UE 120 may transmit the request directly to the second cell 510. In other examples, the UE 120 may transmit the request to the first cell 505 and the first cell 505 may forward the request to the second cell 510 (e.g., in an indication in a similar manner as described in connection with reference number 520). For example, the UE 120 may transmit an uplink communication indicating that the second cell 510 is to transmit the one or more broadcast communications (e.g., SSBs and/or SIB1). In some examples, the request from the UE 120 may be included in an uplink wakeup signal (e.g., a cell wakeup signal) or another type of signal.

As shown by reference number 530, the second cell 510 may transmit (and the UE 120 may receive) an “on-demand” broadcast communication, such as an on-demand SSB and/or an on-demand SIB1. For example, the second cell 510 may transmit the broadcast communication based on, in response to, or otherwise associated with being triggered to transmit the broadcast communication (e.g., by the first cell 505 as described in connection with reference number 520 or by the UE 120 as described in connection with reference number 525). As a result, the UE 120 may be enabled to obtain system information (e.g., RMSI) to enable the UE 120 to perform an initial access operation (e.g., a RACH operation or procedure) to establish a connection with the second cell 510. Additionally, or alternatively, the UE 120 may measure the broadcast communication(s) to obtain measurement information for the second cell 510 (e.g., which may be used to improve one or more operations associated with the UE 120).

As indicated above, FIG. 5 is provided as an example. Other examples may differ from what is described with regard to FIG. 5.

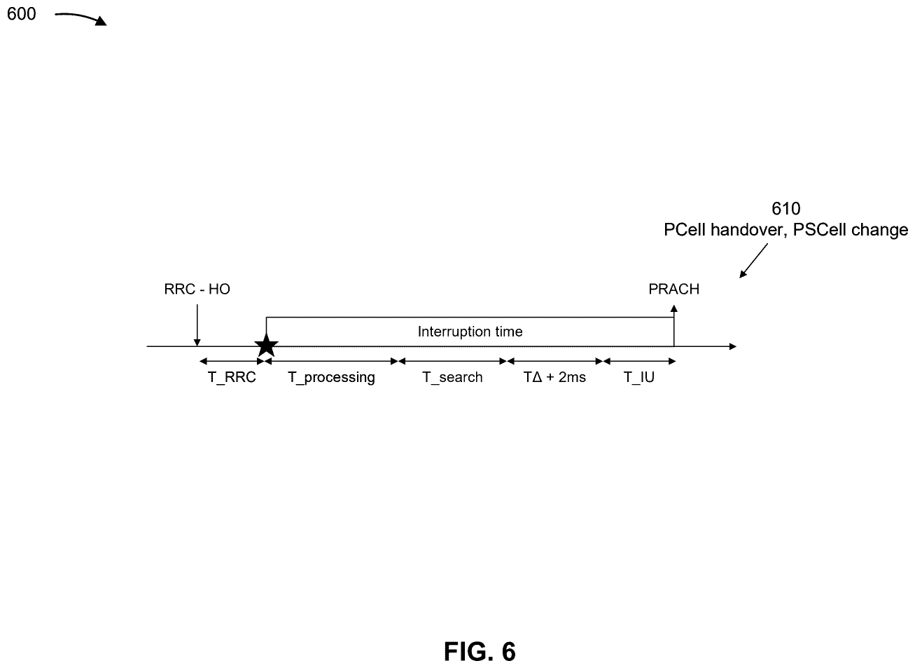

FIG. 6 is a diagram illustrating examples 600 of handover interruption, in accordance with the present disclosure. For example, as described herein, examples 600 generally relate to L3 handover scenarios, where RRC signaling is used to trigger a handover from a source cell to a target cell.

For example, as shown in FIG. 6, reference number 610 illustrates an example timeline that includes various delays for a PCell handover and/or a primary SCell (PSCell) change. As shown, the PCell handover and/or PSCell change may be triggered by L3 signaling that carries a handover command (e.g., shown as “RRC-HO”), which is followed by various delays that result in a handover interruption time. The L3 signaling may be RRC signaling. For example, a UE 120 may receive a handover command from a source cell via an RRC communication. As shown in FIG. 6, the L3 handover command is followed by an RRC procedure delay (e.g., T_RRC), which is followed by an interruption time that includes a UE processing time (e.g., T_processing, which can be up to 20 milliseconds (ms) when the source and target cells are in the same frequency range, or up to 40 ms when the source and target cells are in different frequency ranges) and a search time that the UE uses to search for a target cell (e.g., T_search). The search time may be 0 ms when the target cell is known to the UE when the handover command is received by the UE. As used herein, “known cell” may refer to a cell that the UE has previously measured, evaluated, transmitted a valid measurement report for, and/or obtain information about. For example, a known cell may be a cell for which, during a period of time before reception of a handover command or other command (such as the last 5 seconds prior to the reception), the UE has transmitted a valid measurement report for the cell and at least one of the SSBs measured for the cell remains detectable in accordance with one or more cell identification conditions. An “unknown” cell is a cell that the UE has not previously (or has not recently) measured and/or for which the UE has no (or limited) information. In some examples, when the target cell is an unknown intra-frequency target cell, the search time may be T_rs in FR1, or N×T_rs in FR2 (e.g., where N is 8 for FR2-1 and where N is 12 for FR2-2). When the target cell is an unknown inter-frequency target cell, the search time may be 3×T_rs in FR1, or N×3×T_rs in FR2. T_rs may be an SMTC periodicity of the target cell if the UE has been provided with an SMTC configuration for the target cell in the handover command. Otherwise, T_rs may be an SMTC configured in a measurement object (e.g., an measObjectNR) having the same SSB frequency and subcarrier spacing as the target cell. If the UE does not receive an SMTC configuration or measurement object, then T_rs may be 5 milliseconds, assuming an SSB transmission periodicity of 5 milliseconds. As further shown in FIG. 6, the interruption time may include a synchronization time (e.g., TΔ+2 ms, where TΔ=T_rs) associated with fine time tracking and acquiring full timing information for the target cell, and an interruption uncertainty (e.g., T_IU) that corresponds to the interruption uncertainty in acquiring a first available PRACH occasion (or RACH occasion) in the target cell.

For unknown target cells, a dominant factor for the interruption time may be the search time. For example, for unknown target cells, the search time may make up a largest portion of the interruption time. In some examples, the target cell may be operating in an NES mode. In such examples, the target cell may be capable of transmitting and/or may be configured to transmit on-demand SSBs, as described in more detail elsewhere herein. In such examples, an SMTC periodicity for the target cell may be large, such as 160 milliseconds or larger. For example, the target cell may transmit SSBs less frequently when operating in the NES mode. In such examples, the interruption time for handover to the target cell may significantly increase if the target cell is unknown by the UE. For example, assuming an SMTC period of 160 milliseconds, the search time may be 480 milliseconds for an unknown inter-frequency target cell in FR1. The increased interruption time for handover to the target cell may increase a delay for the UE to complete the handover procedure to the target cell. The increased interruption time may increase latency for data to be transmitted to the UE or transmitted by the UE, may reduce throughput for the UE, and/or may otherwise degrade performance of the UE. For example, during the interruption time, no data may be transmitted to the UE and/or no data may be transmitted by the UE. As a result, a mobility performance of the UE may be degraded because of the increased interruption time during handover to the target cell.

As indicated above, FIG. 6 is provided as an example. Other examples may differ from what is described with regard to FIG. 6.

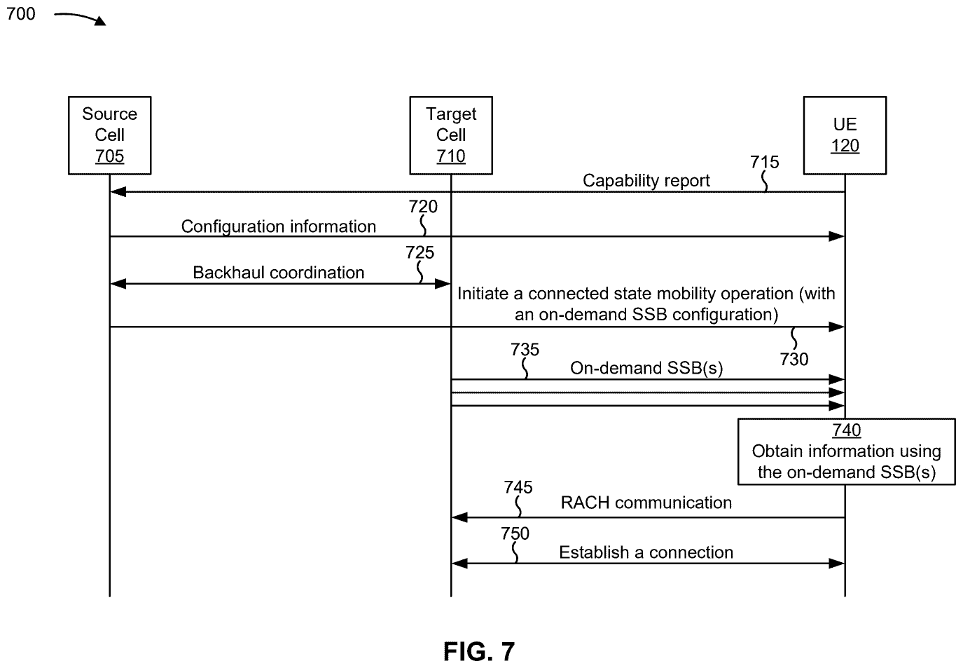

FIG. 7 is a diagram of an example 700 associated with an on-demand SSB configuration for connected state mobility, in accordance with the present disclosure. As shown in FIG. 7, a source cell 705, a target cell 710, and a UE 120 may be in communication with each other. In some aspects, the source cell 705, the target cell 710, and the UE 120 may be part of a wireless network (e.g., the wireless communication network 100). The UE 120 and the source cell 705 may have established a wireless connection prior to operations shown in FIG. 7.

The source cell 705 may be a cell that is initiating a connected state mobility operation for the UE 120. For example, the source cell may be a cell via which the UE 120 has an active or connected RRC connection prior to the start of the connected state mobility operation. The target cell 710 may be a cell via which the UE 120 is to establish a connection (e.g., an RRC connection) as part of the connected state mobility operation. For example, the UE 120 may be operating in a connected state (e.g., an RRC connected state or an RRC active state) via a communication connection with the source cell 705.

The source cell 705 and the target cell 710 may be associated with one or more network nodes 110. A cell may be associated with a network node 110 in that the network node 110 performs or controls one or more operations for the cell. In some aspects, the source cell 705 and the target cell 710 may be associated with the same network node 110 (e.g., the same CU, the same DU, and/or the same base station). Additionally, or alternatively, the source cell 705 and the target cell 710 may be associated with different network nodes 110 (e.g., different CUs, different DUs, different RUs, and/or different base stations). As an example, the source cell 705 may be associated with a first CU and a first DU (and a first RU). The target cell 710 may be associated with the first CU and a second DU (and a second RU). In other aspects, the target cell 710 may be associated with a second CU. In other aspects, the target cell 710 may be associated with the first DU and a second RU.

In some aspects, as shown by reference number 715, the UE 120 may transmit, and the source cell 705 may receive, a capability report. The UE 120 may transmit the capability report via an uplink communication, a UE assistance information (UAI) communication, an uplink control information (UCI) communication, an uplink MAC control element (MAC-CE) communication, an RRC communication, a PUCCH, and/or a PUSCH, among other examples. The capability report may indicate one or more parameters associated with respective capabilities of the UE 120. The one or more parameters may be indicated via respective information elements (IEs) included in the capability report.

The capability report may indicate whether the UE supports a feature and/or one or more parameters related to the feature. For example, the capability report may indicate a capability and/or parameter for using on-demand SSBs as part of a connected state mobility operation (e.g., a handover operation, an RRC release with redirection operation, or another operation). As another example, the capability report may indicate a capability and/or parameter for one or more aspects of the connected state mobility operation. For example, the capability report may indicate a processing capability of the UE 120 (e.g., indicating a processing time (T_processing) for an interruption time of the connected state mobility operation. One or more operations described herein may be based on capability information of the capabilities report. For example, the UE may perform a communication in accordance with the capability information, or may receive configuration information that is in accordance with the capability information. In some aspects, the capability report may indicate UE support for one or more operations described herein. In some aspects, the capability report may indicate one or more capabilities associated with a start time offset value for on-demand SSB transmission for the connected state mobility operation, such as the processing capability of the UE 120.

As shown by reference number 720, the source cell 705 may transmit, and the UE 120 may receive, configuration information. In some aspects, the UE 120 may receive the configuration information via one or more of system information signaling (e.g., a master information block (MIB) and/or a SIB), RRC signaling, MAC signaling (e.g., one or more MAC-CEs), and/or downlink control information (DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to support the use of on-demand SSBs for a connected state mobility operation, as described herein. For example, the configuration information may indicate that the UE 120 is to receive and/or measure on-demand SSBs of source cells (e.g. the source cell 705) during connected state mobility operation, such as handover operations, and/or RRC redirection operations, among other examples.

The UE 120 may configure itself based at least in part on the configuration information. In some aspects, the UE 120 may be configured to perform one or more operations described herein based at least in part on the configuration information.

In some aspects, the configuration information described in connection with reference number 720 and/or the capability report described in connection with reference number 715 may include information transmitted via multiple communications. Additionally, or alternatively, the source cell 705 may transmit the configuration information, or a communication including at least a portion of the configuration information, before and/or after the UE 120 transmits the capability report. For example, the source cell 705 may transmit a first portion of the configuration information before the UE 120 transmits the capability report, the UE 120 may transmit at least a portion of the capability report, and the source cell 705 may transmit a second portion of the configuration information after receiving the capability report.

In some aspects, as shown by reference number 725, the source cell 705 and the target cell 710 may perform backhaul (or midhaul) coordination for a connected state mobility operation of the UE 120. For example, the source cell 705 (or a network node 110) may select the target cell 710 for the connected state mobility operation of the UE 120. For example, the connected state mobility operation may be a handover operation and the source cell 705 (or a network node 110) may select the target cell 710 to be a new serving cell of the UE 120. As an example, the source cell 705 may be a source special cell and the target cell 710 may be a target special cell. As used herein, “special cell” may refer to a PCell of a master cell group (MCG) and/or a PSCell of a secondary cell group (SCG) (e.g., if dual connectivity operation is enabled for the UE 120). If dual connectivity operation is not enabled for the UE 120, “special cell” may refer to a PCell. Special cell may also be referred to as “SpCell.” For example, the connected state mobility operation may be a PCell handover or a PSCell change scenario.

As another example, the source cell 705 may be associated with a first RAT (such as LTE) and the target cell 710 may be associated with a second RAT (such as NR or 6G). In such examples, the connected state mobility operation may be an RRC redirection operation (e.g., from the first RAT to the second RAT).

In some aspects, the UE 120 may transmit, and the source cell 705 may receive, a measurement report indicating one or more measurements of the target cell 710. For example, the target cell 710 may transmit one or more SSBs (e.g., CD-SSBs) with a large SMTC periodicity, such as 160 milliseconds or larger. The UE 120 may measure the one or more SSBs. The measurement report may indicate measurement information (e.g., one or more measurement values) of the target cell 710 and/or one or more other neighbor cells of the UE 120. The source cell 705 (and/or a network node 110) may determine that the target cell 710 is to be the target cell for the connected state mobility operation based on, in response to, or otherwise associated with the measurement information.

The backhaul coordination may include the source cell 705 transmitting, and the target cell 710 receiving, an indication that the target cell 710 is to transmit one or more on-demand SSBs during the connected state mobility operation of the UE 120. In some aspects, the target cell 710 may transmit, and the source cell 705 may receive, an on-demand SSB configuration of the target cell 710. In some aspects, the backhaul coordination may be performed by a central node, such as one or more CUs, not shown in FIG. 7. The backhaul coordination may include triggering the target cell 710 to transmit the one or more on-demand SSBs for the connected state mobility operation of the UE 120. In some aspects, the source cell 705 may transmit, and the target cell 710 may receive, timing information for the connected state mobility operation. For example, the source cell 705 may transmit, and the target cell 710 may receive, an indication of a start time offset indicating an amount of time between the source cell initiating the connected state mobility operation and a time at which the target cell 710 is to being transmitting on-demand SSBs.

As shown by reference number 730, the source cell 705 may transmit, and the UE 120 may receive, one or more communications initiating the connected state mobility operation. For example, the source cell 705 may transmit, and the UE 120 may receive, a communication that is associated with (e.g., that initiates, indicates, triggers, or starts) the connected state mobility operation. The communication may use L3 signaling. For example, the communication may be an RRC communication. As an example, if the connected state mobility operation is a handover operation (e.g., a PCell handover or SpCell change), then the communication may be an RRC communication that includes a handover command. As another example, if the connected state mobility operation is an RRC redirection operation, then the communication may be an RRC release communication that includes a redirection indication (e.g., an RRC release with redirection to NR or another RAT of the target cell 710). For example, the RRC redirection may be to NR, 6G, or another RAT that supports on-demand SSBs.

The communication may include an on-demand SSB configuration of the target cell 710. For example, the source cell 705 may transmit on-demand SSB information of the target cell 710 together with an indication to initiate the connected state mobility operation. For example, the source cell 705 may transmit on-demand SSB information of the target cell 710 together with a handover command in RRC (e.g., for known cells and/or unknown cells). As another example, the source cell 705 may transmit on-demand SSB information of the target cell 710 together with an RRC release with redirection (e.g., to NR) communication.

The on-demand SSB configuration information (e.g., included in the communication transmitted by the source cell 705 as shown by reference number 730) may include time domain resources and/or frequency domain resources of on-demand SSBs to be transmitted by the target cell 710. For example, the source cell 705 may indicate on-demand SSB time location information and frequency location information for the on-demand SSB configuration of the target cell 710. Additionally, or alternatively, the on-demand SSB configuration information (e.g., included in the communication transmitted by the source cell 705 as shown by reference number 730) may include a time gap between burst sets of on-demand SSBs to be transmitted by the target cell 710. The time gap between burst sets may be referred to as a periodicity of the on-demand SSBs. The time gap may be similar to the time gap X shown in FIG. 4, but for on-demand SSBs.

The on-demand SSB configuration information (e.g., included in the communication transmitted by the source cell 705 as shown by reference number 730) may include a quantity of samples included in the on-demand SSBs to be transmitted by the target cell 710 (e.g., a quantity of on-demand SSB samples). “Sample” may refer to an SSB. For example, the quantity of samples may refer to the quantity of SSBs included in a burst set of the on-demand SSBs to be transmitted by the target cell 710. The on-demand SSB configuration information (e.g., included in the communication transmitted by the source cell 705 as shown by reference number 730) may include a start time. The start time may be indicated via a start time offset indicated by the communication transmitted by the source cell 705 as shown by reference number 730. The start time offset may indicate an amount of time between the communication (e.g., transmitted by the source cell 705 as shown by reference number 730) and a time at which the target cell 710 is to start transmitting on-demand SSB(s) in accordance with the on-demand SSB configuration information.

In some aspects, the on-demand SSB configuration information (e.g., included in the communication transmitted by the source cell 705 as shown by reference number 730) may include an indication that the on-demand SSB configuration information is applicable to on-demand SSBs of the target cell 710. For example, the communication transmitted by the source cell 705 may include one or more indications that the SSB information provided in the communication is related to on-demand SSBs of the target cell 710. In some aspects, the communication transmitted by the source cell 705 may include one or more indications that the on-demand SSBs of the target cell 710 are to be used for the connected state mobility operation.

In some aspects, the on-demand SSBs of the target cell 710 may be located at different frequency locations than SSBs (e.g., CD-SSBs) of the target cell 710. For example, the target cell 710 may be associated with an SSB configuration that indicates first frequency domain resources. The on-demand SSB configuration information may indicate that the one or more on-demand SSBs are associated with second frequency domain resources. For example, the one or more on-demand SSBs may be located at the same target cell but the on-demand SSB frequency location may be different from SSB on the target cell 710. In other aspects, the on-demand SSB frequency location may be the same as an SSB frequency location on the target cell 710.

In some aspects, the on-demand SSB configuration information may indicate a quantity of samples included in the on-demand SSBs to be transmitted by the target cell 710. In some aspects, the quantity of samples may be based on or otherwise associated with one or more previous measurements of the target cell performed by the UE 120. For example, if the one or more previous measurements (e.g., indicated in a UE previous measurement report) indicate higher measurement values, then fewer samples may be configured (e.g., to conserve power of the target cell 710 because the UE 120 may be able to receive the on-demand SSBs using fewer samples because of the higher signal quality or strength). If the one or more previous measurements (e.g., indicated in a UE previous measurement report) indicate lower measurement values, then more samples may be configured to improve a likelihood that the UE 120 is able to receive and/or measure the on-demand SSBs.

Additionally, or alternatively, the quantity of samples may be based on or otherwise associated with a frequency range of the target cell 710 (e.g., a higher frequency range may result in more samples being configured). Additionally, or alternatively, the quantity of samples may be based on or otherwise associated with whether the target cell 710 is an intra-frequency cell or an inter-frequency cell with respect to the UE 120. Additionally, or alternatively, the quantity of samples may be based on or otherwise associated with whether the target cell 710 is known or unknown by the UE 120.

For example, if the target cell 710 is known by the UE 120, then the network (e.g., the target cell 710 or another network node 110) may configure at least one on-demand SSB (e.g., at least one sample) for the connected state mobility operation. If the target cell 710 is unknown by the UE 120 and is an intra-frequency cell, then the network (e.g., the target cell 710 or another network node 110) may configure at least two on-demand SSBs (e.g., at least two samples) for the connected state mobility operation for FR1 and N+1 on-demand SSBs (e.g., N+1 samples) for the connected state mobility operation for FR2 (e.g., where N is 8 for FR2-1 and N is 12 for FR2-2). If the target cell 710 is unknown by the UE 120 and is an inter-frequency cell, then the network (e.g., the target cell 710 or another network node 110) may configure at least four on-demand SSBs (e.g., at least four samples) for the connected state mobility operation for FR1 and (N×3)+1 on-demand SSBs (e.g., (N*3)+1 samples) for the connected state mobility operation for FR2 (e.g., where N is 8 for FR2-1 and N is 12 for FR2-2).

In some aspects, the on-demand SSB configuration information may indicate a validity period for the on-demand SSB configuration information. In some aspects, the validity period may be based on or otherwise associated with a start time offset value indicated by the on-demand SSB configuration information and a time at which a RACH communication is transmitted by the UE 120 to the target cell 710 as part of the connected state mobility operation. For example, the source cell 705 may indicate, to the UE 120 (e.g., that supports on-demand SSB-based connected state mobility operations), to perform the connected state mobility operation using on-demand SSBs of the target cell 710, where the on-demand SSB(s) are only valid from a start time (e.g., where the start time is a time at which the communication (shown by reference number 730) is received by the UE 120 plus the start time offset value) to a time at which the UE 120 transmits a RACH communication as part of the connected state mobility operation. For example, when the network (e.g., the source cell 705) has configured on-demand SSBs of the target cell 710 for use for the connected state mobility operation, the UE 120 may expect to use the on-demand SSB(s) for the connected state mobility operation (e.g., a UE 120 supporting on-demand SSB-based connected state mobility operation shall perform the connected state mobility operation using on-demand SSBs when the network configures on-demand SSBs for the UE 120).

As described elsewhere herein, the on-demand SSB configuration information may indicate a start time offset value. The start time offset value may be based on, or otherwise associated with, a capability of the UE 120. For example, the start time offset value may be based on, or otherwise associated with, one or more processing capabilities of the UE 120. For example, the UE 120 indicates or supports a capability (e.g., indicated by the capability report described herein), then the source cell 705 may configure a start time offset value specific to the UE 120 (e.g., that is different than a default start time offset value). Otherwise, if the UE 120 does not support a capability of being configured with a different start time offset value, then the source cell 705 may configure the UE 120 to use the default start time offset value, such as 60 milliseconds. In some aspects, the start time offset value may be at least 60 milliseconds (e.g., for a UE supporting on-demand SSB-based connected state mobility operations). For example, the capability report transmitted by the UE 120 may indicate one or more supported start time offset values for on-demand SSB-based connected state mobility operation. If the UE 120 does not indicate a capability associated with the start time offset value, then the connected state mobility operation may be based on, or otherwise associated with, one or more processing times (e.g., that are defined, or otherwise fixed, by a wireless communication standard, such as the 3GPP). For example, the start time offset value may be based on, or otherwise associated with, an RRC processing time (e.g., T_RRC) and/or a UE processing time (e.g., T_processing), such as the processing times described and depicted in FIG. 6. As another example, the one or more processing times may include an RRC procedure delay (T_RRC_procedure_delay), as defined, or otherwise fixed, by a wireless communication standard, such as the 3GPP. For example, the start time offset value may be based on, or otherwise associated with, T_RRC_procedure_delay plus an additional processing time (e.g., 20 milliseconds), where the additional processing time is associated with RF tune processing by the UE 120 for on-demand SSB measurement.

In some aspects, the on-demand SSB configuration information may indicate whether the one or more on-demand SSBs are to be transmitted by the target cell 710 after a RACH transmission by the UE 120. For example, the on-demand SSB configuration information may indicate whether the target cell 710 is to transmit on-demand SSBs after a completion of the connected state mobility operation. In some aspects, the on-demand SSB configuration information may indicate that the target cell 710 is to transmit on-demand SSBs after a completion of the connected state mobility operation.

In some aspects, the on-demand SSB configuration information may indicate a time gap between burst sets of the one or more on-demand SSBs. A reference signal time (T_rs) for the connected state mobility operation may be based on, or otherwise associated with, the time gap. In some aspects, the reference signal time may be the time gap (e.g., may be the same as the amount of time between burst sets of the one or more on-demand SSBs) when the on-demand SSBs are used for the connected state mobility operation. This may reduce the interruption time for the connected state mobility operation because the time gap may be less than an SMTC periodicity for SSBs transmitted by the target cell 710.

As shown by reference number 735, the target cell 710 may transmit, and the UE 120 may receive, one or more on-demand SSBs in accordance with the on-demand SSB configuration information. For example, the target cell 710 may transmit the one or more SSBs starting at a time that is based on, or otherwise associated with, a time at which the source cell 705 transmits the RRC signaling (shown by reference number 730) plus the start time offset value. The UE 120 may monitor for, detect, measure, and/or receive the one or more on-demand SSBs in accordance with the on-demand SSB configuration information (e.g., indicated by the source cell 705).

As shown by reference number 740, the UE 120 may obtain information using the one or more on-demand SSBs. For example, the UE 120 may obtain measurement information (e.g., one or more measurement values). Additionally, or alternatively, the UE 120 may obtain system information of the target cell 710 (e.g., carried by the one or more on-demand SSBs). The UE 120 may use the information to determine and/or generate a RACH communication to initiate a communication connection with the target cell 710. For example, the UE 120 may obtain random access configuration information of the target cell 710 via the one or more on-demand SSBs. The random access configuration information may include one or more parameters to be used in the random access procedure, such as one or more parameters for transmitting a random access message (RAM) and/or one or more parameters for receiving a random access response (RAR).

The UE 120 may transmit, and the target cell 710 may receive, a communication associated with the connected state mobility operation. The communication may use information indicated by the one or more on-demand SSBs. For example, as shown by reference number 745, the UE 120 may transmit, and the target cell 710 may receive, a RACH communication. The RACH communication may use random access configuration information indicated by the one or more on-demand SSBs. For example, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 750, the UE 120 and the target cell may establish a communication connection based on, in response to, or otherwise associated with the UE 120 transmitting the RACH communication. For example, the target cell 710 may transmit, and the UE 120 may receive, an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3). In some aspects, as part of a second step of a four-step random access procedure, the target cell 710 may transmit a PDCCH communication for the RAR. The PDCCH communication may schedule a PDSCH communication that includes the RAR. For example, the PDCCH communication may indicate a resource allocation for the PDSCH communication. Also as part of a second step of a four-step random access procedure, the target cell 710 may transmit the PDSCH communication for the RAR, as scheduled by the PDCCH communication. The RAR may be included in a MAC PDU of the PDSCH communication.

The UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request). The target cell 710 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. If the UE 120 successfully receives the RRC connection setup message, the UE 120 may transmit a hybrid automatic repeat request (HARQ) acknowledgement (ACK). This may enable the UE 120 and the target cell 710 to establish a communication connection (e.g., an RRC connection). The UE 120 may operate in an RRC connected state with the target cell 710 as the serving cell of the UE 120.

As indicated above, FIG. 7 is provided as an example. Other examples may differ from what is described with respect to FIG. 7.

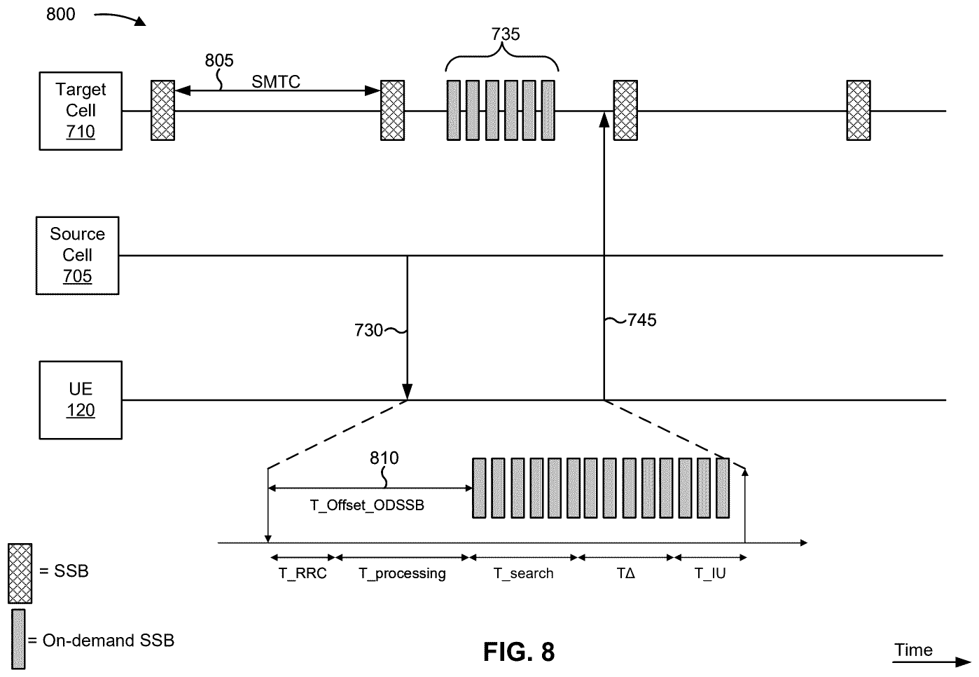

FIG. 8 is a diagram of an example 800 associated with an on-demand SSB configuration for connected state mobility, in accordance with the present disclosure. As shown in FIG. 8, the target cell 710 may be configured to transmit one or more SSBs using an SMTC periodicity 805. The SMTC periodicity 805 may be a relatively large value, such as 160 milliseconds or larger (e.g., meaning that the SSBs are transmitted infrequently by the target cell 710). Therefore, to facilitate a connected state mobility operation for the UE 120 (e.g., a handover operation or an RRC redirection operation), the target cell 710 may transmit one or more on-demand SSBs (e.g., as shown by reference number 735 and described in more detail elsewhere herein).

As shown in FIG. 8, the target cell 710 may begin on-demand SSB transmission after a start time offset value 810 (shown as T_Offset_ODSSB) from a time at which the source cell 705 transmits the communication depicted and described in connection with reference number 730. As described elsewhere herein, a reference signal time used to determine one or more processing times for an interruption time of the connected state mobility operation, such as the search time (T_search) may be based on, or otherwise associated with, a gap between burst sets of the one or more on-demand SSBs (e.g., rather than the SMTC periodicity 805). As a result, an interruption time of the connected state mobility operation may be reduced, reducing latency of delay of data associated with the UE 120 and/or improving mobility performance of the UE 120, among other examples. Additionally, this enables the target cell 710 to transmit SSBs with a large SMTC periodicity 805 without degrading the mobility performance of the UE 120.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with on-demand synchronization signal block configuration for connected state mobility.

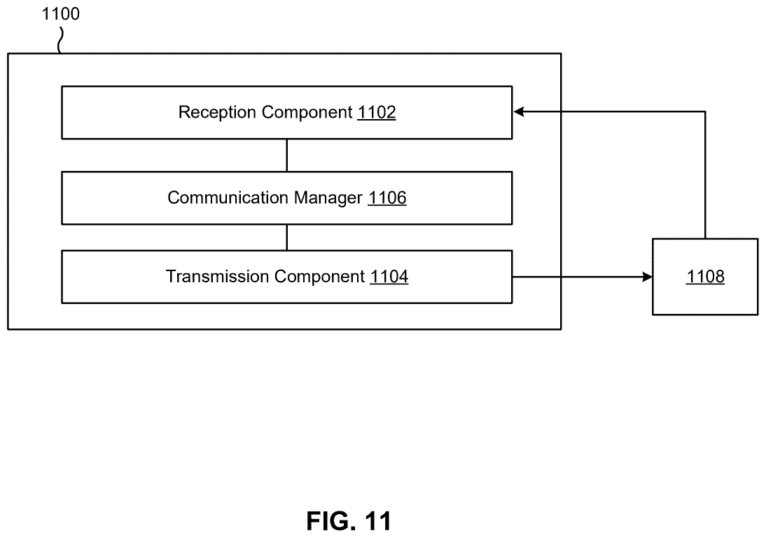

As shown in FIG. 9, in some aspects, process 900 may include receiving, via a first cell, a first communication that is associated with a connected state mobility operation, the first communication indicating on-demand SSB configuration information for a second cell (block 910). For example, the UE (e.g., using reception component 1102 and/or communication manager 1106, depicted in FIG. 11) may receive, via a first cell, a first communication that is associated with a connected state mobility operation, the first communication indicating on-demand SSB configuration information for a second cell, as described above. For example, the first communication may be L3 signaling (e.g., RRC signaling) from the first cell that initiates the connected state mobility operation, such as described in connection with reference number 730 and/or FIG. 7. In some aspects, the connected state mobility operation may be a handover operation (e.g., a PCell handover or a PSCell change). As another example, the connected state mobility operation may be an RRC redirection operation, such as an RRC release with redirection to NR. The first cell may be the source cell 705 and the second cell may be the target cell 710.

As further shown in FIG. 9, in some aspects, process 900 may include receiving, via the second cell, one or more on-demand SSBs in accordance with the on-demand SSB configuration information (block 920). For example, the UE (e.g., using reception component 1102 and/or communication manager 1106, depicted in FIG. 11) may receive, via the second cell, one or more on-demand SSBs in accordance with the on-demand SSB configuration information, as described above. For example, the UE may obtain information from the one or more on-demand SSBs, such as measurement information and/or system information of the second cell. As an example, the information obtained via the one or more on-demand SSBs may include random access configuration information to be used for initial access with the second cell.

As further shown in FIG. 9, in some aspects, process 900 may include transmitting, to the second cell, a second communication associated with the connected state mobility operation, the second communication using information indicated by the one or more on-demand SSBs (block 930). For example, the UE (e.g., using transmission component 1104 and/or communication manager 1106, depicted in FIG. 11) may transmit, to the second cell, a second communication associated with the connected state mobility operation, the second communication using information indicated by the one or more on-demand SSBs, as described above. For example, the second communication may be a RACH communication to establish a communication connection (e.g., an RRC connection) with the second cell, such as described in connection with reference number 745.

Process 900 may include additional aspects, such as any single aspect or any combination of aspects described below and/or in connection with one or more other processes described elsewhere herein.

In a first aspect, the on-demand SSB configuration information includes at least one of time domain resources, domain resources, a time gap between burst sets, a quantity of samples, or a start time.

In a second aspect, alone or in combination with the first aspect, the on-demand SSB configuration information includes an indication that the on-demand SSB configuration information is applicable to on-demand SSBs of the second cell.

In a third aspect, alone or in combination with one or more of the first and second aspects, the second cell is associated with an SSB configuration that indicates first frequency domain resources, and the on-demand SSB configuration information indicates that the one or more on-demand SSBs are associated with second frequency domain resources.

In a fourth aspect, alone or in combination with one or more of the first through third aspects, the on-demand SSB configuration information indicates a quantity of samples.

In a fifth aspect, alone or in combination with one or more of the first through fourth aspects, the quantity of samples is associated with one or more previous measurements of the second cell performed by the UE.

In a sixth aspect, alone or in combination with one or more of the first through fifth aspects, the quantity of samples is associated with a frequency range of the second cell.

In a seventh aspect, alone or in combination with one or more of the first through sixth aspects, the quantity of samples is associated with whether the second cell is an intra-frequency cell or an inter-frequency cell.

In an eighth aspect, alone or in combination with one or more of the first through seventh aspects, the on-demand SSB configuration information indicates that the one or more on-demand SSBs are to be used for the connected state mobility operation.

In a ninth aspect, alone or in combination with one or more of the first through eighth aspects, the on-demand SSB configuration information indicates a validity period, and the validity period is associated with a start time offset value indicated by the on-demand SSB configuration information and a time at which the second communication is transmitted.

In a tenth aspect, alone or in combination with one or more of the first through ninth aspects, the on-demand SSB configuration information indicates a start time offset value.

In an eleventh aspect, alone or in combination with one or more of the first through tenth aspects, the start time offset value is associated with a capability of the UE.

In a twelfth aspect, alone or in combination with one or more of the first through eleventh aspects, the on-demand SSB configuration information indicates whether the one or more on-demand SSBs are to be transmitted after the second communication is transmitted.

In a thirteenth aspect, alone or in combination with one or more of the first through twelfth aspects, the on-demand SSB configuration information indicates a time gap between burst sets of the one or more on-demand SSBs, and a reference signal time for the connected state mobility operation is associated with the time gap between burst sets.

In a fourteenth aspect, alone or in combination with one or more of the first through thirteenth aspects, process 900 includes transmitting a capability report indicating that the UE supports on-demand SSB-based connected state mobility operations.

In a fifteenth aspect, alone or in combination with one or more of the first through fourteenth aspects, the first communication includes a handover command.

In a sixteenth aspect, alone or in combination with one or more of the first through fifteenth aspects, the first communication includes a radio resource control release with redirection communication.

In a seventeenth aspect, alone or in combination with one or more of the first through sixteenth aspects, the second communication is a random access channel communication.

In an eighteenth aspect, alone or in combination with one or more of the first through seventeenth aspects, the first cell is a source cell for the connected state mobility operation, and the second cell is a target cell of the connected state mobility operation.

In a nineteenth aspect, alone or in combination with one or more of the first through eighteenth aspects, the connected state mobility operation is a handover operation.

In a twentieth aspect, alone or in combination with one or more of the first through nineteenth aspects, the connected state mobility operation is a radio resource control redirection operation.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with on-demand synchronization signal block configuration for connected state mobility.

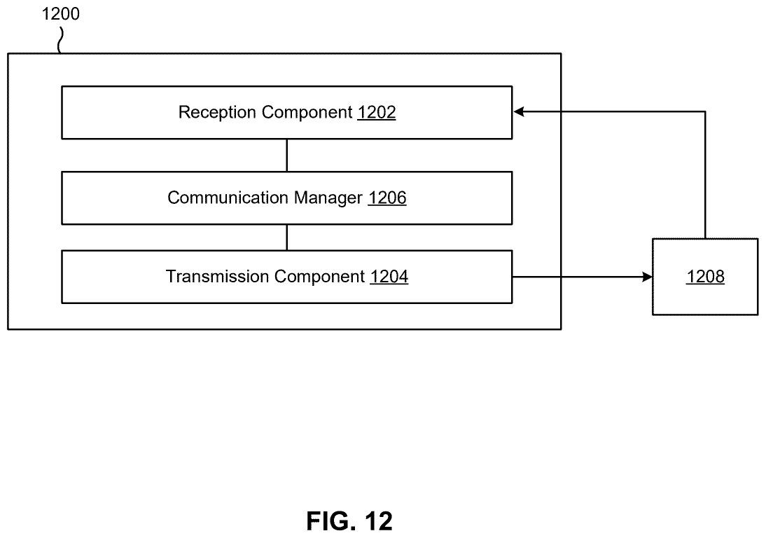

As shown in FIG. 10, in some aspects, process 1000 may include receiving on-demand SSB configuration information for a first cell (block 1010). For example, the network node (e.g., using reception component 1202 and/or communication manager 1206, depicted in FIG. 12) may receive on-demand SSB configuration information for a first cell, as described above. In some aspects, the network node may receive the on-demand SSB configuration via backhaul coordination with the first cell. The first cell may be a target cell (e.g., the target cell 710) that is selected by the network node for a connected mode mobility operation of a UE. The network node may select the first cell using one or more measurements of the first cell performed by the UE.

As further shown in FIG. 10, in some aspects, process 1000 may include transmitting, via a second cell and for a user UE, a communication that is associated with a connected state mobility operation, the communication indicating the on-demand SSB configuration information (block 1020). For example, the network node (e.g., using transmission component 1204 and/or communication manager 1206, depicted in FIG. 12) may transmit, via a second cell and for a UE, a communication that is associated with a connected state mobility operation, the communication indicating the on-demand SSB configuration information, as described above. For example, the communication may be L3 signaling (e.g., RRC signaling) that initiates the connected state mobility operation, such as described in connection with reference number 730 and/or FIG. 7. In some aspects, the connected state mobility operation may be a handover operation (e.g., a PCell handover or a PSCell change). As another example, the connected state mobility operation may be an RRC redirection operation, such as an RRC release with redirection to NR.

Process 1000 may include additional aspects, such as any single aspect or any combination of aspects described below and/or in connection with one or more other processes described elsewhere herein.

In a first aspect, the on-demand SSB configuration information includes at least one of time domain resources, domain resources, a time gap between burst sets, a quantity of samples, or a start time.

In a second aspect, alone or in combination with the first aspect, the on-demand SSB configuration information includes an indication that the on-demand SSB configuration information is applicable to on-demand SSBs of the first cell.

In a third aspect, alone or in combination with one or more of the first and second aspects, the first cell is associated with an SSB configuration that indicates first frequency domain resources, and the on-demand SSB configuration information indicates second frequency domain resources.

In a fourth aspect, alone or in combination with one or more of the first through third aspects, the on-demand SSB configuration information indicates a quantity of samples.

In a fifth aspect, alone or in combination with one or more of the first through fourth aspects, the quantity of samples is associated with one or more previous measurements of the second cell performed by the UE.

In a sixth aspect, alone or in combination with one or more of the first through fifth aspects, the quantity of samples is associated with a frequency range of the second cell.

In a seventh aspect, alone or in combination with one or more of the first through sixth aspects, the quantity of samples is associated with whether the second cell is an intra-frequency cell or an inter-frequency cell.

In an eighth aspect, alone or in combination with one or more of the first through seventh aspects, the on-demand SSB configuration information indicates that one or more on-demand SSBs are to be used for the connected state mobility operation.

In a ninth aspect, alone or in combination with one or more of the first through eighth aspects, the on-demand SSB configuration information indicates a validity period, and the validity period is associated with a start time offset value indicated by the on-demand SSB configuration information.

In a tenth aspect, alone or in combination with one or more of the first through ninth aspects, on-demand SSB configuration information indicates a start time offset value.

In an eleventh aspect, alone or in combination with one or more of the first through tenth aspects, the start time offset value is associated with a capability of the UE.

In a twelfth aspect, alone or in combination with one or more of the first through eleventh aspects, the on-demand SSB configuration information indicates a time gap between burst sets, and a reference signal time for the connected state mobility operation is associated with the time gap between burst sets.

In a thirteenth aspect, alone or in combination with one or more of the first through twelfth aspects, process 1000 includes receiving a capability report indicating that the UE supports on-demand SSB-based connected state mobility operations.

In a fourteenth aspect, alone or in combination with one or more of the first through thirteenth aspects, the communication includes a handover command.

In a fifteenth aspect, alone or in combination with one or more of the first through fourteenth aspects, the communication includes a radio resource control release with redirection communication.

In a sixteenth aspect, alone or in combination with one or more of the first through fifteenth aspects, the second cell is a source cell for the connected state mobility operation, and the first cell is a target cell of the connected state mobility operation.

In a seventeenth aspect, alone or in combination with one or more of the first through sixteenth aspects, the connected state mobility operation is a handover operation.

In an eighteenth aspect, alone or in combination with one or more of the first through seventeenth aspects, the connected state mobility operation is a radio resource control redirection operation.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, via a first cell, a first communication that is associated with a connected state mobility operation, the first communication indicating on-demand SSB configuration information for a second cell. The reception component 1102 may receive, via the second cell, one or more on-demand SSBs in accordance with the on-demand SSB configuration information. The transmission component 1104 may transmit, to the second cell, a second communication associated with the connected state mobility operation, the second communication using information indicated by the one or more on-demand SSBs.

The transmission component 1104 may transmit a capability report indicating that the UE supports on-demand SSB-based connected state mobility operations.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive on-demand SSB configuration information for a first cell. The transmission component 1204 may transmit, via a second cell and for a UE, a communication that is associated with a connected state mobility operation, the communication indicating the on-demand SSB configuration information.

The reception component 1202 may receive a capability report indicating that the UE supports on-demand SSB-based connected state mobility operations.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving, via a first cell, a first communication that is associated with a connected state mobility operation, the first communication indicating on-demand synchronization signal block (SSB) configuration information for a second cell; receiving, via the second cell, one or more on-demand SSBs in accordance with the on-demand SSB configuration information; and transmitting, to the second cell, a second communication associated with the connected state mobility operation, the second communication using information indicated by the one or more on-demand SSBs.
Aspect 2: The method of Aspect 1, wherein the on-demand SSB configuration information includes at least one of: time domain resources, frequency domain resources, a time gap between burst sets, a quantity of samples, or a start time.
Aspect 3: The method of any of Aspects 1-2, wherein the on-demand SSB configuration information includes an indication that the on-demand SSB configuration information is applicable to on-demand SSBs of the second cell.
Aspect 4: The method of any of Aspects 1-3, wherein the second cell is associated with an SSB configuration that indicates first frequency domain resources, and wherein the on-demand SSB configuration information indicates that the one or more on-demand SSBs are associated with second frequency domain resources.
Aspect 5: The method of any of Aspects 1-4, wherein the on-demand SSB configuration information indicates a quantity of samples.
Aspect 6: The method of Aspect 5, wherein the quantity of samples is associated with one or more previous measurements of the second cell performed by the UE.
Aspect 7: The method of any of Aspects 5-6, wherein the quantity of samples is associated with a frequency range of the second cell.
Aspect 8: The method of any of Aspects 5-7, wherein the quantity of samples is associated with whether the second cell is an intra-frequency cell or an inter-frequency cell.
Aspect 9: The method of any of Aspects 1-8, wherein the on-demand SSB configuration information indicates that the one or more on-demand SSBs are to be used for the connected state mobility operation.
Aspect 10: The method of any of Aspects 1-9, wherein the on-demand SSB configuration information indicates a validity period, and wherein the validity period is associated with a start time offset value indicated by the on-demand SSB configuration information and a time at which the second communication is transmitted.
Aspect 11: The method of any of Aspects 1-10, wherein the on-demand SSB configuration information indicates a start time offset value.
Aspect 12: The method of Aspect 11, wherein the start time offset value is associated with a capability of the UE.
Aspect 13: The method of any of Aspects 1-12, wherein the on-demand SSB configuration information indicates whether the one or more on-demand SSBs are to be transmitted after the second communication is transmitted.
Aspect 14: The method of any of Aspects 1-13, wherein the on-demand SSB configuration information indicates a time gap between burst sets of the one or more on-demand SSBs, and wherein a reference signal time for the connected state mobility operation is associated with the time gap between burst sets.
Aspect 15: The method of any of Aspects 1-14, further comprising: transmitting a capability report indicating that the UE supports on-demand SSB-based connected state mobility operations.
Aspect 16: The method of any of Aspects 1-15, wherein the first communication includes a handover command.
Aspect 17: The method of any of Aspects 1-16, wherein the first communication includes a radio resource control release with redirection communication.
Aspect 18: The method of any of Aspects 1-17, wherein the second communication is a random access channel communication.
Aspect 19: The method of any of Aspects 1-18, wherein the first cell is a source cell for the connected state mobility operation, and wherein the second cell is a target cell of the connected state mobility operation.
Aspect 20: The method of any of Aspects 1-19, wherein the connected state mobility operation is a handover operation.
Aspect 21: The method of any of Aspects 1-20, wherein the connected state mobility operation is a radio resource control redirection operation.
Aspect 22: A method of wireless communication performed by a network node, comprising: receiving on-demand synchronization signal block (SSB) configuration information for a first cell; and transmitting, via a second cell and for a user equipment (UE), a communication that is associated with a connected state mobility operation, the communication indicating the on-demand SSB configuration information.
Aspect 23: The method of Aspect 22, wherein the on-demand SSB configuration information includes at least one of: time domain resources, frequency domain resources, a time gap between burst sets, a quantity of samples, or a start time.
Aspect 24: The method of any of Aspects 22-23, wherein the on-demand SSB configuration information includes an indication that the on-demand SSB configuration information is applicable to on-demand SSBs of the first cell.
Aspect 25: The method of any of Aspects 22-24, wherein the first cell is associated with an SSB configuration that indicates first frequency domain resources, and wherein the on-demand SSB configuration information indicates second frequency domain resources.
Aspect 26: The method of any of Aspects 22-25, wherein the on-demand SSB configuration information indicates a quantity of samples.
Aspect 27: The method of Aspect 26, wherein the quantity of samples is associated with one or more previous measurements of the second cell performed by the UE.
Aspect 28: The method of any of Aspects 26-27, wherein the quantity of samples is associated with a frequency range of the second cell.
Aspect 29: The method of any of Aspects 26-28, wherein the quantity of samples is associated with whether the second cell is an intra-frequency cell or an inter-frequency cell.
Aspect 30: The method of any of Aspects 22-29, wherein the on-demand SSB configuration information indicates that one or more on-demand SSBs are to be used for the connected state mobility operation.
Aspect 31: The method of any of Aspects 22-30, wherein the on-demand SSB configuration information indicates a validity period, and wherein the validity period is associated with a start time offset value indicated by the on-demand SSB configuration information.
Aspect 32: The method of any of Aspects 22-31, wherein on-demand SSB configuration information indicates a start time offset value.
Aspect 33: The method of Aspect 32, wherein the start time offset value is associated with a capability of the UE.
Aspect 34: The method of any of Aspects 22-33, wherein the on-demand SSB configuration information indicates a time gap between burst sets, and wherein a reference signal time for the connected state mobility operation is associated with the time gap between burst sets.
Aspect 35: The method of any of Aspects 22-34, further comprising: receiving a capability report indicating that the UE supports on-demand SSB-based connected state mobility operations.
Aspect 36: The method of any of Aspects 22-35, wherein the communication includes a handover command.
Aspect 37: The method of any of Aspects 22-36, wherein the communication includes a radio resource control release with redirection communication.
Aspect 38: The method of any of Aspects 22-37, wherein the second cell is a source cell for the connected state mobility operation, and wherein the first cell is a target cell of the connected state mobility operation.
Aspect 39: The method of any of Aspects 22-38, wherein the connected state mobility operation is a handover operation.
Aspect 40: The method of any of Aspects 22-39, wherein the connected state mobility operation is a radio resource control redirection operation.
Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.
Aspect 42: An apparatus for wireless communication at a device, the apparatus comprising one or more memories and one or more processors coupled to the one or more memories, the one or more processors configured to cause the device to perform the method of one or more of Aspects 1-40.
Aspect 43: An apparatus for wireless communication, the apparatus comprising at least one means for performing the method of one or more of Aspects 1-40.
Aspect 44: A non-transitory computer-readable medium storing code for wireless communication, the code comprising instructions executable by one or more processors to perform the method of one or more of Aspects 1-40.
Aspect 45: A non-transitory computer-readable medium storing a set of instructions for wireless communication, the set of instructions comprising one or more instructions that, when executed by one or more processors of a device, cause the device to perform the method of one or more of Aspects 1-40.
Aspect 46: A device for wireless communication, the device comprising a processing system that includes one or more processors and one or more memories coupled with the one or more processors, the processing system configured to cause the device to perform the method of one or more of Aspects 1-40.
Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, via a first cell, a first communication that is associated with a connected state mobility operation, the first communication indicating on-demand synchronization signal block (SSB) configuration information for a second cell;
receive, via the second cell, one or more on-demand SSBs in accordance with the on-demand SSB configuration information; and
transmit, to the second cell, a second communication associated with the connected state mobility operation, the second communication using information indicated by the one or more on-demand SSBs.

2. The UE of claim 1, wherein the on-demand SSB configuration information includes at least one of:
time domain resources,
frequency domain resources,
a time gap between burst sets,
a quantity of samples, or
a start time.

3. The UE of claim 1, wherein the on-demand SSB configuration information includes an indication that the on-demand SSB configuration information is applicable to on-demand SSBs of the second cell.

4. The UE of claim 1, wherein the second cell is associated with an SSB configuration that indicates first frequency domain resources, and
wherein the on-demand SSB configuration information indicates that the one or more on-demand SSBs are associated with second frequency domain resources.

5. The UE of claim 1, wherein the on-demand SSB configuration information indicates a quantity of samples.

6. The UE of claim 5, wherein the quantity of samples is associated with one or more previous measurements of the second cell performed by the UE.

7. The UE of claim 5, wherein the quantity of samples is associated with a frequency range of the second cell.

8. The UE of claim 5, wherein the quantity of samples is associated with whether the second cell is an intra-frequency cell or an inter-frequency cell.

9. A method of wireless communication performed by a user equipment (UE), comprising:
receiving, via a first cell, a first communication that is associated with a connected state mobility operation, the first communication indicating on-demand synchronization signal block (SSB) configuration information for a second cell;
receiving, via the second cell, one or more on-demand SSBs in accordance with the on-demand SSB configuration information; and
transmitting, to the second cell, a second communication associated with the connected state mobility operation, the second communication using information indicated by the one or more on-demand SSBs.

10. The method of claim 9, wherein the on-demand SSB configuration information includes at least one of:
time domain resources,
frequency domain resources,
a time gap between burst sets,
a quantity of samples, or
a start time.

11. The method of claim 9, wherein the on-demand SSB configuration information indicates that the one or more on-demand SSBs are to be used for the connected state mobility operation.

12. The method of claim 9, wherein the on-demand SSB configuration information indicates a validity period, and wherein the validity period is associated with a start time offset value indicated by the on-demand SSB configuration information and a time at which the second communication is transmitted.

13. The method of claim 9, wherein the on-demand SSB configuration information indicates a start time offset value.

14. The method of claim 13, wherein the start time offset value is associated with a capability of the UE.

15. The method of claim 9, wherein the on-demand SSB configuration information indicates whether the one or more on-demand SSBs are to be transmitted after the second communication is transmitted.

16. The method of claim 9, wherein the on-demand SSB configuration information indicates a time gap between burst sets of the one or more on-demand SSBs, and
wherein a reference signal time for the connected state mobility operation is associated with the time gap between burst sets.

17. The method of claim 9, further comprising:
transmitting a capability report indicating that the UE supports on-demand SSB-based connected state mobility operations.

18. A non-transitory computer-readable medium storing a set of instructions for wireless communication, the set of instructions comprising:
one or more instructions that, when executed by one or more processors of a user equipment (UE), cause the UE to:
receive, via a first cell, a first communication that is associated with a connected state mobility operation, the first communication indicating on-demand synchronization signal block (SSB) configuration information for a second cell;
receive, via the second cell, one or more on-demand SSBs in accordance with the on-demand SSB configuration information; and
transmit, to the second cell, a second communication associated with the connected state mobility operation, the second communication using information indicated by the one or more on-demand SSBs.

19. The non-transitory computer-readable medium of claim 18, wherein the on-demand SSB configuration information includes at least one of:
time domain resources,
frequency domain resources,
a time gap between burst sets,
a quantity of samples, or
a start time.

20. The non-transitory computer-readable medium of claim 18, wherein the on-demand SSB configuration information includes an indication that the on-demand SSB configuration information is applicable to on-demand SSBs of the second cell.
